(19) United States
(12) Patent Application Publication
(10) Pub. No.: US 2008/0065870 A1
(43) Pub. Date: Mar. 13, 2008

(54) Information processing apparatus

(75) Inventor: Toshiaki Saruwatari, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/699,494

(22) Filed: Jan. 30, 2007

(30) Foreign Application Priority Data
Sep. 13, 2006 (JP) 2006-248258

(51) Int. Cl. G06F 9/40

(52) U.S. Cl. 712/235; 712/205

(57) ABSTRACT

An information processing apparatus characterized by having a memory interface with a buffer for reading and buffering an instruction stored in memory, an instruction decoder decoding a program counter relative branch instruction supplied from the above-mentioned memory interface, and extracting a program counter relative branch destination address in the above-mentioned program counter relative branch instruction, and a judgment section judging whether an instruction at the above-mentioned program counter relative branch destination address exists in the buffer in the above-mentioned memory interface on the basis of the above-mentioned program counter relative branch destination address in the same cycle as a cycle of the above-mentioned instruction decoder decoding the above-mentioned program counter relative branch instruction.

### CROSS-REFERENCE TO RELATED APPLICATIONS

This application is based upon and claims the benefit of priority from the prior Japanese Patent Application No. 2006-248258, filed on Sep. 13, 2006, the entire contents of which are incorporated herein by reference.

### BACKGROUND OF THE INVENTION

1. Field of the Invention

The present invention relates to an information processing apparatus which processes a branch instruction, and in particular, to an information processing apparatus which can avoid an empty slot at the run time of a relative branch instruction in a pipeline operation.

2. Description of the Related Art

A processor which performs a pipeline operation adopts structure which can supply one or more instructions in one cycle to suppress occurrence of an empty slot of a pipeline. Nevertheless, since a processor performing an instruction fetch, instruction decode, and an execution by pipeline processing must decode a next instruction before executing a branch instruction, when a branch actually occurs, an empty slot arises in a pipeline to become a penalty.

Furthermore, recently, with acceleration of flash memory and the like, direct connection of flash memory has increased instead of ROM and cache memory directly connected to a processor. However, since acceleration of a processor is earlier than acceleration of memory (flash memory etc.), it is not possible to operate at the same speed as the processor like ROM and cache memory, and hence, it is made to be able to supply one or more instructions in one cycle in regard to a sequential operation by providing a buffer in a memory interface.

In addition, an information processing apparatus having a prefetch buffer fetching instructions by a plurality of times of length of instruction length, and storing the instructions prefetched, a decoder decoding an instruction stored in the above-mentioned prefetch buffer, an arithmetic unit executing the above-mentioned decoded instruction, an instruction request control circuit performing a prefetch request of a branch destination instruction at the time of decoding the branch instruction, and performing a prefetch request of an instruction sequentially otherwise, and a prefetch control circuit fetching a branch destination instruction into the above-mentioned prefetch buffer when it branches by a branch instruction, or disregarding when it does not branch is disclosed in Japanese Patent No. 3683248.

When memory which cannot operate at the same speed as a processor is connected as memory for instruction supply, when a branch instruction is generated, delay of memory is reflected in an instruction fetch as it is, and hence, an empty slot is generated in a pipeline.

### SUMMARY OF THE INVENTION

The present invention aims at providing an information processing apparatus which does not use a large-scale circuit but can avoid an empty slot at the time of running a program counter relative branch instruction in simple logic.

According to an aspect of the present invention, an information processing apparatus is provided, which has a memory storing a plurality of instructions including a program counter relative branch instruction, a memory interface with a buffer for reading and buffering an instruction stored in the above-mentioned memory, an instruction decoder decoding a program counter relative branch instruction supplied from the above-mentioned memory interface, and extracting a program counter relative branch destination address in the above-mentioned program counter relative branch instruction, a judgment section judging whether an instruction at the above-mentioned program counter relative branch destination address exists in the buffer in the above-mentioned memory interface on the basis of the above-mentioned program counter relative branch destination address in the same cycle as a cycle of the above-mentioned instruction decoder decoding the above-mentioned program counter relative branch instruction, and in which, when the judgment section judges that an instruction at the program counter relative branch destination address exists in the buffer in the memory interface, the memory interface reads the instruction at the program counter relative branch destination address from the buffer, and outputs the instruction to the instruction decoder.

### BRIEF DESCRIPTION OF THE DRAWINGS

FIG. 1 is a diagram showing a structural example of an information processing apparatus according to a first embodiment of the present invention;

FIG. 2 is a diagram showing an example of a computer program (instruction group) which is a processing object of the first embodiment;

FIG. 3 is a timing chart showing an operation of an information processing apparatus in the case that there is no hit/miss judgment section;

FIG. 4 is a timing chart showing an operation example of the information processing apparatus according to the first embodiment;

FIG. 5 is a timing chart showing an operation example of an information processing apparatus according to a second embodiment; and

FIG. 6 is a timing chart showing an operation example of an information processing apparatus according to a third embodiment.

### DETAILED DESCRIPTION OF THE PREFERRED EMBODIMENTS

### Embodiment 1

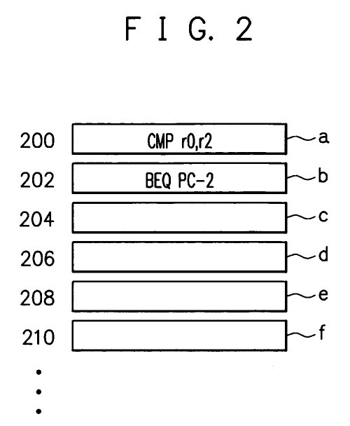

FIG. 2 is a diagram showing an example of a computer program (instruction group) a to f which is a processing object of a first embodiment of the present invention. Each of instructions a to f has, for example, 16 bits of instruction length. One byte (8 bits) is memorizable in one address, for example, instructions a to f are stored in a 200th address to a 210th address. When this program is executed, the instruction a is first executed. In the instruction a, for example, values of registers r0 and r2 are compared. Next, the instruction b is executed. The instruction b is an instruction for making a branch to a destination address PC-2 executed when registers r0 and r2 are the same as a result of the above-mentioned comparison, or making instructions executed sequentially without branching when not the same. Such the instruction b is a branch instruction. A branch instruction includes a conditional branch instruction and/or an unconditional branch instruction. The conditional branch instruction is an instruction making a branch executed according to a condition, such as a comparison result like the instruction b. The unconditional branch instruction is an instruction making an unconditional branch executed, such as a CALL instruction or a JUMP instruction.

This branch instruction b is a PC (program counter) relative branch instruction, and has a PC relative branch destination address. A PC is a program counter and is a register showing an address where an instruction to be executed next is stored. For example, a value of the PC becomes a 202nd address when the branch instruction b is decoded. A PC relative branch destination address is a relative branch destination address on the basis of the PC. For example, when the PC relative branch destination address of the branch instruction b is “−2”, since a relative value is “−2” on the basis of the 202nd address in the PC, the branch destination address becomes a 200th address. That is, in the branch instruction b, when the registers r0 and r2 are the same, a branch to the 200th address is executed and an instruction a is executed, but, when the registers r0 and r2 are different, an instruction c at a 204th address is executed.

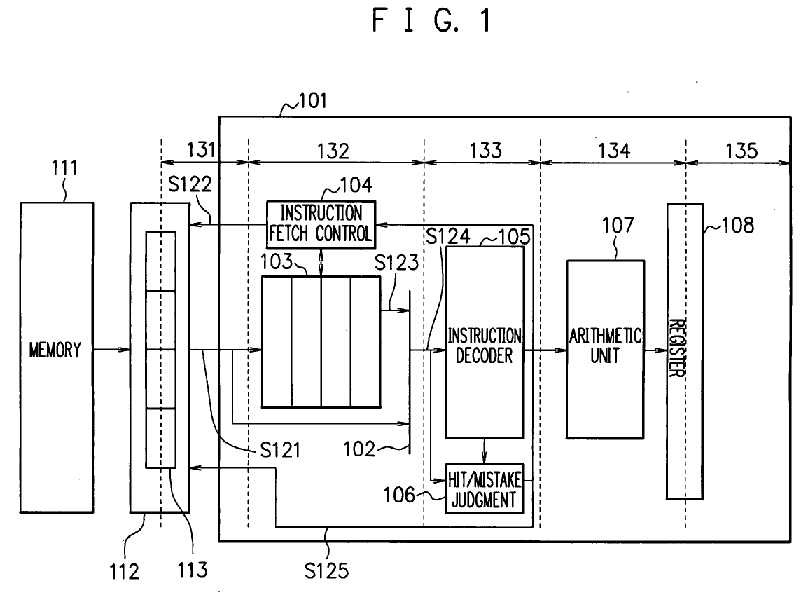

FIG. 1 is a diagram showing a structural example of an information processing apparatus according to a first embodiment of the present invention. This information processing apparatus performs five stages of pipeline processing, that is, an instruction (address) request stage (hereinafter, an IA stage) 131, an instruction fetch stage (hereinafter, an IF stage) 132, an instruction decode stage (hereinafter, an ID stage) 133, an execution stage (hereinafter, an EX stage) 134, and a register write stage (hereinafter, a WB stage) 135.

A processor 101 is connected to memory 111 through a memory interface 112. The memory 111 is, for example, SDRAM or flash memory and is connected to the memory interface 112 through a 64-bit-width bus. For example, the memory 111 stores a plurality of instructions including a PC relative branch instruction in FIG. 2. The memory interface 112 has a buffer 113 reading and buffering instructions stored in the memory 111. The buffer 113 has 64-bit memory size, and can buffer four instructions. One instruction length is 16 bits, for example. The memory interface 112 reads four instructions from the memory 111 in one cycle. For example, the memory interface 112 reads four instruction a to d at continuous 200th to 206th addresses when receiving a request of the instruction a from the processor 101. In addition, the memory interface 112 reads four instruction e to h at continuous addresses when receiving a request of an instruction e from the processor 101. That is, the memory interface 112 reads instructions at continuous addresses from the memory 111 per four pieces.

A case that an instruction which the processor 101 requests is on the buffer 113 is called a buffer hit. When a buffer hit is performed, the processor 101 can receive the instruction from the buffer 113. On the other hand, a case that an instruction which the processor 101 requests is not on the buffer 113 is called a buffer miss. In the case of the buffer miss, the memory interface 112 issues a read out request of an instruction to the memory 111. The processor 101 can read the instruction from the memory 111 through the memory interface 112.

The processor 101 has a selector 102, an instruction queue (instruction buffer) 103, an instruction fetch controller 104, an instruction decoder 105, a hit/miss judgment section 106, an arithmetic unit 107, and a register 108. The instruction queue 103 can store, for example, four 16-bit-length instructions at maximum, and is connected between the memory interface 112 and the instruction decoder 105. The selector 102 selects an instruction S121 which the memory interface 112 outputs, or an instruction S123 which the instruction queue 103 outputs, and outputs a selected instruction S124 to the instruction decoder 105 and hit/miss judgment section 106. The instruction fetch controller 104 outputs a memory access control signal S122 for performing an instruction request to the memory interface 112, and controls input/output of the instruction queue 103. The instruction decoder 105 decodes the output instruction S124 of the selector 102 per one instruction. The arithmetic unit 107 executes (calculates) an instruction which the instruction decoder 105 decodes per one instruction. An execution result of the arithmetic unit 107 is written into the register 108.

An instruction fetch operation is performed by the instruction fetch controller 104 issuing an instruction request to the memory interface 112 (IA stage 131) according to a state of the processor 101, and fetching instructions into the instruction queue 103 in a next cycle (IF stage 132). Next, by decoding a first instruction in the instruction queue 103 by the instruction decoder 105 (ID stage 133), performing an operation designated by the instruction in a next cycle by the arithmetic unit 107 (EX stage 134), and performing rewrite to the register 108 (WB stage 135), one instruction is completed. The processor 101 performs these operations in a pipeline.

The instruction decoder 105 extracts a PC relative branch destination address in a PC relative branch instruction when an instruction which the instruction decoder 105 decodes is the PC relative branch instruction, and outputs the PC relative branch destination address and a PC value to the hit/miss judgment section 106. For example, in the case of FIG. 2, a branch instruction is the instruction b, the PC relative branch destination address is “−2”, and the PC value is “202”. Thus, an absolute branch destination address becomes a 200th address. The number of instructions (for example, 4) which the buffer 113 can store is set in the hit/miss judgment section 106. When the output instruction S124 of the selector 102 is a PC relative branch instruction, the hit/miss judgment section 106 judges whether a branch destination address instruction exists in the buffer 113 (a buffer hit or a buffer miss), on the basis of the PC relative branch destination address, PC value, and number of instructions which the buffer 113 can store. For example, since the instructions a to d at the 200th to 206th addresses are stored in the buffer 113, it is possible to judge that the instruction a at the 200th address which is a branch destination address exists in the buffer 113. When a branch destination address instruction exists in the buffer 113, since the hit/miss judgment section 106 can also recognize a position of the instruction in the buffer 113, it outputs a buffer designation signal S125 for outputting an instruction in the position in the buffer 113 to the memory interface 112. When the buffer designation signal S125 is inputted, the memory interface 112 outputs the instruction in the position designated in the buffer 113 as an instruction S121. The selector 102 selects the instruction S121, and outputs it to the instruction decoder 105 as the instruction S124. Thereby, the instruction decoder 105 can decode the instruction S124. That is, after the instruction decoder 105 decodes the branch instruction b, it is possible to decode the branch destination instruction a in the next cycle without an empty slot. In addition, in a conditional branch instruction, it is possible to known whether the condition is fulfilled by bypass processing, without waiting for completion of execution of the EX stage 134.

When judging that a branch destination address instruction does not exist in the buffer 113, the hit/miss judgment section 106 outputs a control signal to the instruction fetch controller 104 to request the branch destination address instruction. The instruction fetch controller 104 outputs a memory access control signal S122 to the memory interface 112 according to the control signal. The memory interface 112 reads the requested instruction from the memory 111 and outputs it as the instruction S121 while buffering it in the buffer 113. Then, similarly to the above, the selector 102 selects the instruction S121, and outputs it to the instruction decoder 105.

In addition, the instruction queue 103 has a function as a buffer for buffering difference between a processing speed of the processor 101 and a processing speed of the memory 111, and can be also deleted. When the instruction queue 103 is deleted, the memory interface 112 will output an instruction to the instruction decoder 105 directly.

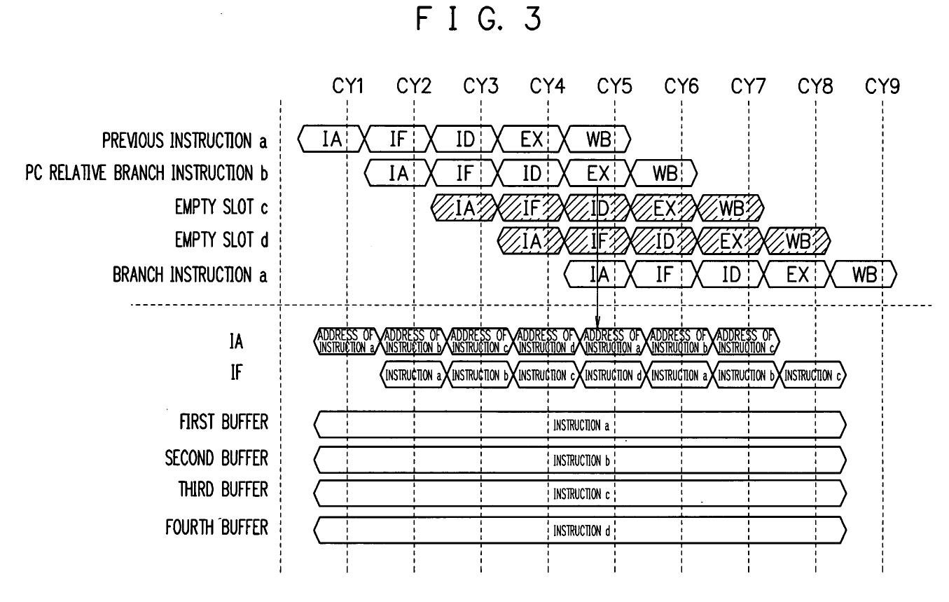

FIG. 3 is a timing chart showing an operation of an information processing apparatus in the case that there is no hit/miss judgment section 106 in FIG. 1, for reference. A case of processing the program in FIG. 2 will be explained as an example. First to fourth buffers show buffers corresponding to four instructions in the buffer 113.

In a cycle CY1, in the buffer 113, four instructions a to d are stored and an instruction request of the instruction a is performed on the IA stage 131. Next, in a cycle CY2, the instruction a is fetched on the IF stage 132, and an instruction request of the PC relative branch instruction b is performed on the IA stage 131.

Since the branch instruction b is a conditional branch instruction, it is not possible to perform a conditional judgment until the EX stage 134 of the branch instruction b starts, and hence, it is not decided whether a branch is performed or not. Therefore, two empty slots c and d arise as mentioned later.

Next, in a cycle CY3, the instruction a is decoded on the ID stage 133, and the PC relative branch instruction b is fetched on the IF stage 132. Next, in a cycle CY4, the instruction a is executed on the EX stage 134, and the PC relative branch instruction b is decoded on the ID stage 133. In a cycle CY5, the instruction a is written into the register on the WB stage 135, and the PC relative branch instruction b is executed on the EX stage 134. When a conditional judgment is performed without waiting for completion of execution on the EX stage 134 and a branch destination instruction is decided to be the instruction a, an instruction request of the branch destination instruction a is performed in the cycle CY5 on the IA stage 131. On this occasion, as prediction, although it is also possible to perform an instruction request of the instruction c in the cycle CY3 on the IA stage 131, and to perform an instruction request of the instruction d in the cycle CY4 on the IA stage 131, when it is decided that a branch destination instruction is the instruction a, these processings become useless and two empty slots c and d arise.

Next, in a cycle CY6, the PC relative branch instruction b is written into the register on the WB stage 135, and the branch destination instruction a is fetched on the IF stage 132. Next, in a cycle CY7, the branch destination instruction a is decoded on the ID stage 133. Subsequently, in a cycle CY8, the branch destination instruction a is executed on the EX stage 134. Next, in a cycle CY9, the branch destination instruction a is written into the register on the WB stage 135.

As described above, when branching, two empty slots c and d shown by hatching arise, and hence, it is not possible to perform efficient pipeline processing. Since it is not possible to perform a condition judgment of branching until the EX stage 134 of the branch instruction b, a penalty is generated by waiting a judgment of whether a branch destination instruction is fetched subsequently or whether a sequential instruction is fetched as it is. In addition, when a branch prediction is performed and the prediction is not right, a penalty is generated.

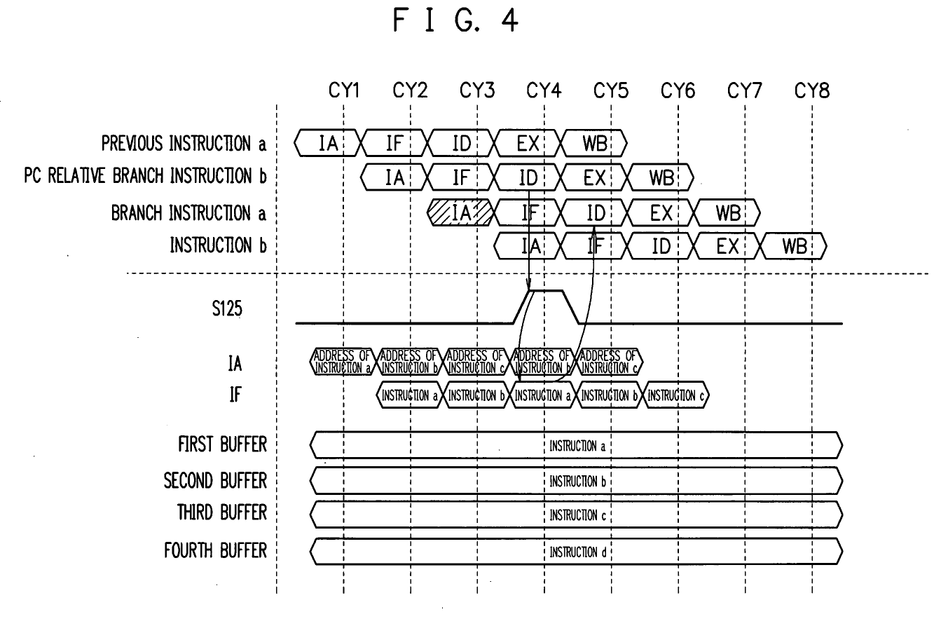

FIG. 4 is a timing chart showing an operation example of the information processing apparatus according to this embodiment in FIG. 1. A case of processing the program in FIG. 2 will be explained as an example. First to fourth buffers show buffers corresponding to four instructions in the buffer 113.

In a cycle CY1, in the buffer 113, four instructions a to d are stored and an instruction request of the instruction a is performed on the IA stage 131. Next, in a cycle CY2, the instruction a is fetched on the IF stage 132, and an instruction request of the PC relative branch instruction b is performed on the IA stage 131.

Next, in a cycle CY3, the instruction a is decoded on the ID stage 133, and the PC relative branch instruction b is fetched on the IF stage 132. On this occasion, it is not necessary to perform an instruction request of the branch destination instruction a shown by hatching on the IA stage 131. In addition, it is preferable to perform the instruction request of the instruction c as a prediction on the IA stage 131.

Next, in a cycle CY4, the instruction a is executed on the EX stage 134, and the PC relative branch instruction b is decoded on the ID stage 133, and the branch destination instruction a is fetched on the IF stage 132, and an instruction request of the next instruction b is performed on the IA stage 131. The instruction decoder 105 outputs a PC relative branch destination address and a PC value to the hit/miss judgment section 106 when the PC relative branch instruction b is inputted. When the PC relative branch instruction b is inputted, the hit/miss judgment section 106 judges whether the branch destination instruction a exists in the buffer 113, and when it exists, a buffer designation signal S125 is outputted to the memory interface 112. Then, the memory interface 112 outputs the branch destination instruction a in the buffer 113 to the instruction decoder 105 through the selector 102. That is, the memory interface 112 reads the instruction at the program counter relative branch destination address from the buffer 113 with bypassing the instruction buffer 103, and outputs it to the instruction decoder 105.

Next, in a cycle CY5, the instruction a is written into the register on the WB stage 135, and the PC relative branch instruction b is executed on the EX stage 134. When a conditional judgment is performed without waiting for completion of execution on the EX stage 134 and a branch destination instruction is decided to be the instruction a, the branch destination instruction a is decoded on the ID stage 133, and the next instruction b is fetched on the IF stage 132.

Subsequently, in a cycle CY6, the PC relative branch instruction b is written into the register on the WB stage 135, and the branch destination instruction a is executed on the EX stage 134, and the next instruction b is decoded on the ID stage 133. Next, in a cycle CY7, the branch instruction a is written into the register on the WB stage 135, and the next instruction b is executed on the EX stage 134. Next, in a cycle CY8, the instruction b is written into the register on the WB stage 135.

As described above, according to this embodiment, an empty slot does not arise, but it is possible to perform efficient pipeline processing.

In addition, in the case of not branching by performing an instruction request of the instruction c in the cycle CY3 on the IA stage 131, the instruction c is fetched on the IF stage 132 in a following cycle CY4, and subsequently, it is possible to perform processing on the ID stage 133, EX stage 134, and WB stage 135. Also when not branching, it is possible to perform efficient pipeline processing without an empty slot.

In this embodiment, the hit/miss judgment section 106 judging a buffer hit or a buffer miss on the basis of a PC value, a PC relative branch destination address, and size of the buffer 113 is provided in the ID stage 133. When the instruction decoder 105 decodes the PC relative branch instruction b, the hit/miss judgment section 106 outputs a signal S125 performing selection instruction of the buffer 113 to the memory interface 112. At the same time, it informs also the instruction fetch controller 104 of the signal S125, and when it is a buffer hit, the instruction b is requested at a following address in a branch destination, and when it is a buffer miss, the instruction a is requested at the branch destination address as it is.

The instruction fetch controller 104 requests the instruction a at a PC relative branch destination address to the memory interface 112 when the hit/miss judgment section 106 judges that the instruction a at the program counter relative branch destination address does not exist in the buffer 113 in the memory interface 112.

Furthermore, when the processor 101 has the instruction queue 103, the instruction fetch controller 104 outputs a control signal of the selector 102. The selector 102 selects an output instruction S123 of the instruction queue 103, or an output instruction S121 of the memory interface 112 according to the control signal.

In addition, when the buffer hit signal S125 is asserted, the memory interface 112 discards the prior request, and returns the instruction in the buffer 113, designated by the signal S125, to the processor 101 in the same cycle. When the buffer hit signal S125 is not asserted, a usual memory access is performed.

The hit/miss judgment section 106 asserts the buffer hit signal S125 at the time of decoding the PC relative branch instruction b, and the memory interface 112 replaces the instruction c, which is scheduled to be outputted, with the branch destination instruction a. Furthermore, when the hit/miss judgment section 106 reports the signal S125 to the instruction fetch controller 104, the instruction request address in the same cycle is changed into the instruction b following the branch destination instruction a. Hence, when hitting the buffer 113 in the memory interface 112, it becomes accessible without generating a stall in a pipeline.

That is, the instruction fetch controller 104 requests the instruction b following the instruction a when the hit/miss judgment section 106 judges that an instruction at a PC relative branch destination address exists in the buffer 113 in the memory interface 112.

In addition, since the hit/miss judgment section 106 requires only comparison of PC relative branch destination address at the time of a branch, there is little influence on circuit size.

The memory interface 112 reads instructions (for example, four instructions) at a plurality of continuous addresses in the memory 111 in the same cycle, and writes them in the buffer 113. In addition, the memory interface 112 reads a plurality of instructions from the memory 111 with making a block (a block of four instructions), divided in the same size, in the memory as a unit, and writes them in the buffer 113.

The judgment section 106 judges whether an instruction at the program counter relative branch destination address exists in the buffer 113 in the memory interface 112 on the basis of the PC relative branch destination address, PC value, and block size in the same cycle as a cycle of the same instruction decoder 105 decoding the PC relative branch instruction b.

When the hit/miss judgment section 106 judges that an instruction at the program counter relative branch destination address exists in the buffer 113 in the memory interface 112, the memory interface 112 reads the instruction at the PC relative branch destination address from the buffer 113, and outputs it to the instruction decoder 105.

### Embodiment 2

As to a second embodiment of the present invention, a case that a branch instruction b in FIG. 2 is a delayed branch instruction will be explained. First, the delayed branch instruction will be explained. As for a conditional branch instruction, if a condition holds, a branch to a branch destination occurs, and, if not, the branch does not occur. As for the delayed branch instruction b, when not branching, instructions c, d, e, and f are executed sequentially after the instruction b, and when branching, instructions c, a, and b are sequentially executed after the instruction b. That is, the instruction c after the delayed branch instruction b is always executed irrespective of the presence of branching, and a branch occurs after that. The instruction c after the delayed branch instruction b is called a delayed slot instruction.

Structure of an information processing apparatus of this embodiment is the same as that in FIG. 1. Hereafter, points that this embodiment is different from the first embodiment will be explained.

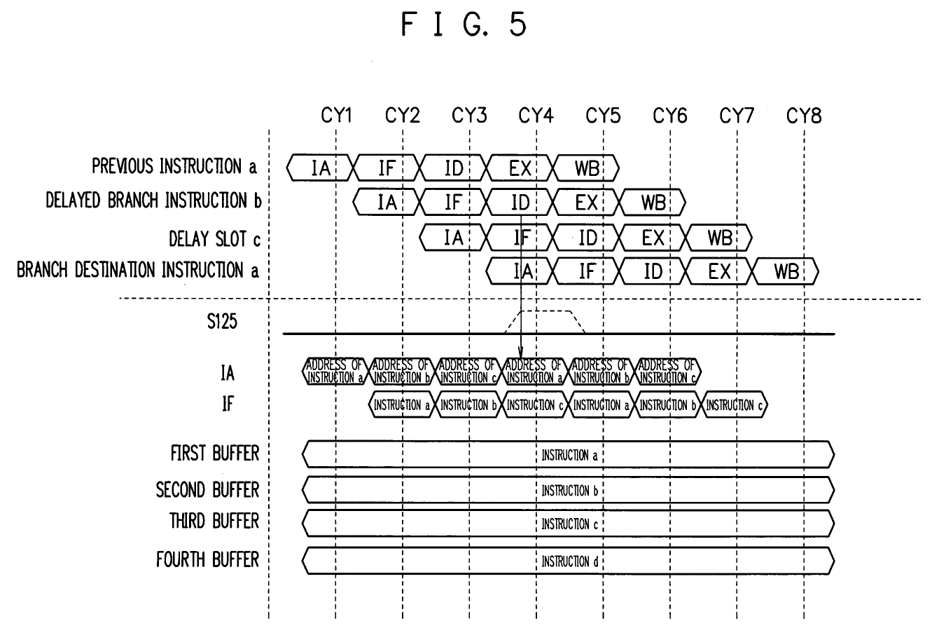

FIG. 5 is a timing chart showing an operation example of the information processing apparatus according to the second embodiment of the present invention. A case of processing the program, including the delayed branch instruction b, in FIG. 2 will be explained as an example. First to fourth buffers show buffers corresponding to four instructions in the buffer 113.

In a cycle CY1, in the buffer 113, four instructions a to d are stored and an instruction request of the instruction a is performed on the IA stage 131. Next, in a cycle CY2, the instruction a is fetched on the IF stage 132, and an instruction request of the delayed branch instruction b is performed on the IA stage 131. Subsequently, in a cycle CY3, the instruction a is decoded on the ID stage 133, the delayed branch instruction b is fetched on the IF stage 132, and an instruction request of the delayed slot instruction c is performed on the IA stage 131.

Next, in a cycle CY4, the instruction a is executed on the EX stage 134, the delayed branch instruction b is decoded on the ID stage 133, the delayed slot instruction c is fetched on the IF stage 132, and an instruction request of the branch destination instruction a is performed on the IA stage 131. When the delayed branch instruction b is inputted, the hit/miss judgment section 106 does not make a buffer hit signal S125 assert, but outputs an instruction request designation signal of the branch destination instruction a to the instruction fetch controller 104. Then, the instruction fetch controller 104 outputs a memory access control signal S122 to the memory interface 112. Then, the memory interface 112 outputs the branch destination instruction a in the buffer 113 to the processor 101.

Subsequently, in a cycle CY5, the instruction a is written into the register on the WB stage 135, the delayed branch instruction b is executed on the EX stage 134, the delayed slot instruction c is decoded on the ID stage 133, and the branch destination instruction a is fetched on the IF stage 132. Next, in a cycle CY6, the delayed branch instruction b is written into the register on the WB stage 135, the delayed slot instruction c is executed on the EX stage 134, and the branch destination instruction a is decoded on the ID stage 133. Subsequently, in a cycle CY7, the delayed slot instruction c is written into the register on the WB stage 135, and the branch destination instruction a is executed on the EX stage 134. Next, in a cycle CY8, the branch destination instruction a is written into the register on the WB stage 135.

As mentioned above, when the delayed branch instruction b is inputted, the hit/miss judgment section 106 does not make the buffer hit signal S125 assert, but outputs the instruction request designation signal of the branch destination instruction a to the instruction fetch controller 104. When a PC relative branch instruction which the instruction decoder 105 decodes is a delayed branch instruction, regardless of an operation of the hit/miss judgment section 106, the memory interface 112 outputs an instruction at the PC relative branch destination address to the instruction decoder 105 according to an instruction request by the instruction fetch controller 104. According to this embodiment, an empty slot does not arise, but it is possible to perform efficient pipeline processing.

### Embodiment 3

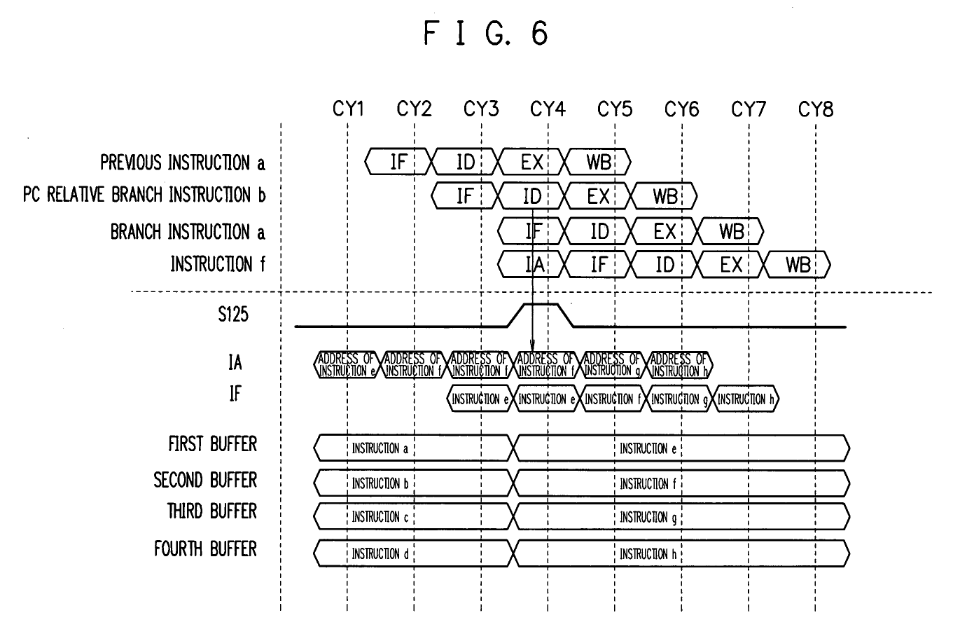

FIG. 6 is a timing chart showing an operation example of an information processing apparatus according to a third embodiment of the present invention. In this embodiment, a case that a branch destination address of the branch instruction b in FIG. 2 is an address of an instruction e and the processor 101 performs a prefetch operation will be explained as an example. First to fourth buffers show buffers corresponding to four instructions in the buffer 113. Structure of the information processing apparatus of this embodiment is the same as that in FIG. 1. Hereafter, points that this embodiment is different from the first embodiment will be explained.

In a cycle CY1, four instructions a to d are stored in the buffer 113, and the instruction fetch controller 104 performs an instruction prefetch request of the branch destination instruction e on the IA stage 131 to the memory interface 112. However, since the branch destination instruction e in the buffer 113 does not exist, the memory interface 112 does not immediately output the branch destination instruction e to the processor 101.

Next, in cycles CY2 and CY3, the instruction fetch controller 104 performs an instruction prefetch request of an instruction f on the IA stage 131 to the memory interface 112. In addition, in the cycle CY2, the instruction a has been already fetched and has existed in the instruction queue 103 on the IF stage 132.

Next, in a cycle CY3, the instruction a is decoded on the ID stage 133. The PC relative branch instruction b has been already fetched and has existed in the instruction queue 103 on the IF stage 132. In addition, in a cycle CY3, the memory interface 112 reads instructions e to h from the memory 111, and outputs the instruction e to the IF stage 132 of the processor 101.

Next, in a cycle CY4, the instruction a is executed on the EX stage 134, the PC relative branch instruction b is decoded on the ID stage 133, the branch destination instruction e is fetched on the IF stage 132, and an instruction request of the next instruction f is performed on the IA stage 131. That is, the instruction fetch controller 104 suspends the instruction prefetch request of the instruction f, and performs an instruction request of the instruction f following the branch destination instruction e.

The memory interface 112 writes four instructions e to h in the buffer 113. The instruction fetch controller 104 outputs a signal showing that an instruction in the buffer 113 is changed to the hit/miss judgment section 106. Thereby, the hit/miss judgment section 106 can recognize the instruction which exists in the current buffer 113.

The instruction decoder 105 outputs a PC relative branch destination address and a PC value to the hit/miss judgment section 106 when the PC relative branch instruction b is inputted. When the PC relative branch instruction b is inputted, the hit/miss judgment section 106 judges whether the branch destination instruction e exists in the buffer 113, and when it exists, the buffer designation signal S125 is outputted to the memory interface 112. Then, the memory interface 112 outputs the branch destination instruction e in the buffer 113 to the instruction decoder 105 through the selector 102.

Next, in a cycle CY5, the instruction a is written into the register on the WB stage 135, the PC relative branch instruction b is executed on the EX stage 134, the branch destination instruction e is decoded on the ID stage 133, and the next instruction f is fetched on the IF stage 132. Next, in a cycle CY6, the PC relative branch instruction b is written into the register on the WB stage 135, the branch destination instruction e is executed on the EX stage 134, and the next instruction f is decoded on the ID stage 133. Subsequently, in a cycle CY7, the branch instruction e is written into the register on the WB stage 135, and the next instruction f is executed on the EX stage 134. Next, in a cycle CY8, the instruction f is written into the register on the WB stage 135.

As described above, an instruction in the buffer 113 may be rewritten by a prefetch operation of the processor 101. In that case, the instruction fetch controller 104 informs the hit/miss controller 106 of the instruction which exists in the buffer 113 now. Thereby, the hit/miss controller 106 can judge accurately whether the branch destination instruction e in the buffer 113 exists.

In the cycle CY4, the memory interface 112 reads an instruction from the memory 111 according to a instruction prefetch request from the instruction prefetch controller 104, and replaces the instruction in the buffer 113 with the above mentioned read instruction. The hit/miss judgment section 106 performs the above-mentioned judgment according to replacement information of the instruction in the buffer 113.

As described above, according to the first to third embodiments, when the instruction decoder 105 in the processor 101 decodes the PC relative branch instruction b, at the same time, the hits hit/miss judgment section 106 judges whether it hits or misses the buffer 113 in the memory interface 112. When the hit/miss judgment section 106 outputs the buffer hit signal S125 to the memory interface 112, the memory interface 112 outputs the branch destination instruction in the buffer 113, can fetch a branch destination instruction, and can avoid a penalty of a PC relative branch instruction. In addition, it is possible to reduce a penalty at the time of connecting the low-speed memory 111 to the processor 101. In particular, in the case of a program with many short loops, an effect becomes remarkable.

Since the PC relative branch instruction b includes a PC relative branch destination address as a branch destination address in an instruction code, the hit/miss judgment section 106 does not need to compare full address bits, and hence, a small-scale comparator is sufficient. Furthermore, since there is also little circuit delay of the hit/miss judgment section 106, the hit/miss judged result signal S125 is outputted to the memory interface 112, and it becomes also possible to perform an instruction fetch as it is.

It is possible to avoid an empty slot at the time of running a program counter relative branch instruction in simple logic, and to perform efficient pipeline processing, without using a large-scale circuit.

In addition, all the above-mentioned embodiments are only what show specific examples at the time of implementing the present invention, and the technical scope of the present invention must not be restrictively interpreted by these. That is, the present invention can be implemented in various forms without deviating from its technological idea or its main features.

What is claimed is:

1. An information processing apparatus, comprising:
a memory storing a plurality of instructions including a program counter relative branch instruction;
a memory interface with a buffer for reading and buffering an instruction stored in the memory;
an instruction decoder decoding a program counter relative branch instruction supplied from the memory interface, and extracting a program counter relative branch destination address in the program counter relative branch instruction; and
a judgment section judging whether an instruction at the program counter relative branch destination address exists in the buffer in the memory interface on the basis of the program counter relative branch destination address in the same cycle as a cycle of the instruction decoder decoding the program counter relative branch instruction,
wherein, when the judgment section judges that an instruction at the program counter relative branch destination address exists in the buffer in the memory interface, the memory interface reads the instruction at the program counter relative branch destination address from the buffer, and outputs the instruction to the instruction decoder.

2. The information processing apparatus according to claim 1, further comprising:
an arithmetic unit executing an instruction decoded by the instruction decoder; and
a register writing an execution result of the arithmetic unit.

3. The information processing apparatus according to claim 1, further comprising:
an instruction buffer provided between the memory interface and the instruction decoder,
wherein the memory interface reads an instruction at the program counter relative branch destination address from the buffer with bypassing the instruction buffer, and outputs the instruction to the instruction decoder.

4. The information processing apparatus according to claim 1, further comprising:
an instruction fetch controller performing an instruction request to the memory interface,
wherein, when a program counter relative branch instruction which the instruction decoder decodes is a delayed branch instruction, regardless of an operation of the judgment section, the memory interface outputs the instruction at the program counter relative branch destination address to the instruction decoder according to an instruction request by the instruction fetch controller.

5. The information processing apparatus according to claim 1, further comprising:
an instruction fetch controller performing an instruction request to the memory interface,
wherein, when the judgment section judges that an instruction at the program counter relative branch destination address exists in the buffer in the memory interface, the instruction fetch controller requests an instruction following the instruction at the program counter relative branch destination address.

6. The information processing apparatus according to claim 1, further comprising:
an instruction fetch controller performing an instruction prefetch request to the memory interface,
wherein the memory interface reads an instruction from the memory according to the instruction prefetch request, and replaces the instruction in the buffer with the instruction read; and
wherein the judgment section performs the judgment according to replacement information of the instruction in the buffer.

7. The information processing apparatus according to claim 1,
wherein the memory interface reads instructions at a plurality of continuous addresses in the memory in the same cycle, and writes them in the buffer.

8. The information processing apparatus according to claim 1,
wherein the memory interface reads a plurality of instructions from the memory with making a block, divided in the same size, in the memory as a unit, and writes them in the buffer.

9. The information processing apparatus according to claim 8,
wherein the judgment section judges whether an instruction at the program counter relative branch destination address exists in the buffer in the memory interface on the basis of the program counter relative branch destination address, a program counter value, and the block size.

10. The information processing apparatus according to claim 1, further comprising:
an instruction fetch controller requesting an instruction at the program counter relative branch destination address to the memory interface when the judgment section judges that the instruction at the program counter relative branch destination address does not exist in the buffer in the memory interface.

11. The information processing apparatus according to claim 2, further comprising:
an instruction buffer provided between the memory interface and the instruction decoder,
wherein the memory interface reads an instruction at the program counter relative branch destination address from the buffer with bypassing the instruction buffer, and outputs the instruction to the instruction decoder.

12. The information processing apparatus according to claim 2, further comprising:
an instruction fetch controller performing an instruction request to the memory interface,
wherein, when a program counter relative branch instruction which the instruction decoder decodes is a delayed branch instruction, regardless of an operation of the judgment section, the memory interface outputs the instruction at the program counter relative branch destination address to the instruction decoder according to an instruction request by the instruction fetch controller.

13. The information processing apparatus according to claim 2, further comprising:
an instruction fetch controller performing an instruction request to the memory interface,
wherein, the instruction fetch controller requests an instruction following the instruction at the program counter relative branch destination address when the judgment section judges that the instruction at the program counter relative branch destination address exists in the buffer in the memory interface.

14. The information processing apparatus according to claim 2, further comprising:
an instruction fetch controller performing an instruction prefetch request to the memory interface,
wherein the memory interface reads an instruction from the memory according to the instruction prefetch request, and replaces the instruction in the buffer with the instruction read; and
wherein the judgment section performs the judgment according to replacement information of the instruction in the buffer.

15. The information processing apparatus according to claim 2,
wherein the memory interface reads instructions in a plurality of continuous addresses in the memory in the same cycle, and writes them in the buffer.

16. The information processing apparatus according to claim 2,
wherein the memory interface reads a plurality of instructions from the memory with making a block, divided in the same size, in the memory as a unit, and writes them in the buffer.

17. The information processing apparatus according to claim 16,
wherein the judgment section judges whether an instruction at the program counter relative branch destination address exists in the buffer in the memory interface on the basis of the program counter relative branch destination address, a program counter value, and the block size.

18. The information processing apparatus according to claim 2, further comprising:
an instruction fetch controller requesting an instruction at the program counter relative branch destination address to the memory interface when the judgment section judges that the instruction at the program counter relative branch destination address does not exist in the buffer in the memory interface.
